(19) United States
(12) Patent Application Publication
(10) Pub. No.: US 2025/0392190 A1
(43) Pub. Date: Dec. 25, 2025

(54) ELECTRIC DRIVE UNIT

(71) Applicant: Schaeffler Technologies AG & Co. KG, Herzogenaurach (DE)

(72) Inventors: Antonio Eduardo Mogro Zambrano, Puebla (MX); Kyle Nelson, Delaware, OH (US); Christopher Chapanar, Massillon, OH (US); Andreas Rosenwald, Nürnberg (DE); Maximilian Podschwadt, Saline, MI (US)

(73) Assignee: Schaeffler Technologies AG & Co. KG, Herzogenaurach (DE)

(21) Appl. No.: 18/750,486

(22) Filed: Jun. 21, 2024

(51) Int. Cl. H02K 7/116; H02K 7/08

(52) U.S. Cl. CPC H02K 7/116; H02K 7/08

(57) ABSTRACT

An electric drive unit includes a motor that drives rotation of a rotor shaft about an axis, and a housing. The housing includes a bearing shield between motor housing and gearbox regions. The bearing shield has a first side that faces toward the motor housing region and a second side that includes adjacent reference and protruding portions. The protruding portion protrudes axially outward relative to the reference portion away from the motor housing region. The reference portion is radially aligned with the protruding portion, the protruding portion extends circumferentially between first and second circumferential ends of the protruding portion in a first circumferential direction, the reference portion extends from the second circumferential end to the first circumferential end in the first circumferential direction, and a circumferential extent of the protruding portion delimited by the first and second circumferential ends is between 20 and 50 percent of a full circumference.

### FIELD OF THE DISCLOSURE

The present disclosure generally relates to electric drive units for vehicles. More specifically, the present disclosure relates to an electric drive unit that includes a housing having a bearing shield with a protruding portion and a reference portion.

### BACKGROUND OF THE DISCLOSURE

Electric drive units often include gearboxes that serve as oil reservoirs. Oil is often splashed within these gearboxes by gears and other moving components to lubricate and cool various components of the electric drive unit.

### SUMMARY OF THE DISCLOSURE

According to a first aspect of the present disclosure, an electric drive unit includes a motor, a housing, and a planetary gearset. The motor drives rotation of a rotor shaft about an axis. The housing includes a bearing shield that extends between a motor housing region that houses the motor and a gearbox region. The bearing shield has a first side that faces toward the motor housing region and a second side opposite the first side that includes a protruding portion. The planetary gearset is disposed within the gearbox region. The planetary gearset includes a sun gear and a plurality of planet gears. The sun gear includes a sun gear engagement face and is operably coupled with the rotor shaft such that the sun gear and the rotor shaft are configured to rotate together at a common rate of rotation about the axis. The plurality of planet gears each has a planet gear engagement face that meshes with the sun gear engagement face at a gear junction, such that rotation of the sun gear about the axis prompts each planet gear to revolve about the axis and rotate about a respective planet gear axis. For each of the plurality of planet gears respectively, a radially distal zone of the planet gear engagement face that is circumferentially aligned with the gear junction and radially outboard and opposite of the portion of the planet gear engagement face that is meshed with the sun gear engagement face at the gear junction is radially aligned with the protruding portion of the second side of the bearing shield. Further, when the radially distal zone of the planet gear engagement face is circumferentially aligned with the protruding portion, the radially distal zone of the planet gear engagement face is nearer to the second side of the bearing shield than the radially distal zone of the planet gear engagement face is when the radially distal zone of the planet gear engagement face is circumferentially offset from the protruding portion.

Embodiments of the first aspect of the disclosure can include any one or a combination of the following features:
the protruding portion of the second side of the bearing shield protrudes outward in an axial direction away from the first side of the bearing shield relative to an adjacent portion of the second side of the bearing shield;
the protruding portion of the second side of the bearing shield extends circumferentially between first and second circumferential ends of the protruding portion that delimit a circumferential extent of the protruding portion;
the circumferential extent of the protruding portion is no more than 50 percent of a full circumference;
the circumferential extent of the protruding portion is between 20 percent and 50 percent of a full circumference;
the circumferential extent of the protruding portion is no more than 35 percent of a full circumference;
the circumferential extent of the protruding portion is about 35 percent of a full circumference;
the protruding portion of the second side of the bearing shield includes a beveled portion that extends to the adjacent portion of the bearing shield;
the housing includes an outlet that defines an opening for fluid to flow through from the gearbox region and along a fluid flow path therefrom, wherein the outlet is adjacent to the beveled portion proximate the first circumferential end; and
revolution of the planet gears about the axis and rotation of each of the planet gears about the respective planet gear axes prompted by rotation of the operably coupled rotor shaft is configured to splash fluid that is radially and circumferentially aligned with the protruding portion toward the opening defined by the outlet.

According to a second aspect of the present disclosure, an electric drive unit includes a motor, a housing, and a planetary gearset. The motor drives rotation of a rotor shaft about an axis. The housing includes a bearing shield that extends between a motor housing region that houses the motor and a gearbox region. The bearing shield has a first side that faces toward the motor housing region and a second side opposite the first side that includes a reference portion and a protruding portion that is adjacent to the reference portion and that protrudes axially outward relative to the reference portion away from the motor housing region. The planetary gearset is disposed within the gearbox region. The planetary gearset has a planet gear that is meshed with a sun gear at a gear junction and that has a radially-outboard-most portion. A radially-aligned portion of the second side of the bearing shield that is radially aligned with the radially-outboard-most portion of the planet gear is formed by the reference portion and the protruding portion. Further, the radially-outboard-most portion of the planet gear is axially offset from the portion of the radially-aligned portion that is formed by the protruding portion less than the radially-outboard-most portion of the planet gear is axially offset from the portion of the radially-aligned portion that is formed by the reference portion.

Embodiments of the second aspect of the disclosure can include any one or a combination of the following features:
the radially-aligned portion of the second side extends along a full circumference;
the reference portion and the protruding portion form the entirety of the radially-aligned portion of the second side of the bearing shield;
the reference portion forms a greater percentage of the radially-aligned portion than the protruding portion;
the protruding portion forms between 20 percent and 40 percent of the radially-aligned portion; and
the protruding portion includes a beveled portion that is adjacent to the reference portion.

According to a third aspect of the present disclosure, an electric drive unit includes a motor that drives rotation of a rotor shaft about an axis and a housing. The housing includes a bearing shield that extends between a motor housing region that houses the motor and a gearbox region. The bearing shield has a first side that faces toward the motor housing region and a second side opposite the first side that includes a reference portion and a protruding portion that is adjacent to the reference portion and that protrudes axially outward relative to the reference portion away from the motor housing region. The reference portion is radially aligned with the protruding portion, the protruding portion extends circumferentially between first and second circumferential ends of the protruding portion in a first circumferential direction, the reference portion extends from the second circumferential end of the protruding portion to the first circumferential end of the protruding portion in the first circumferential direction, and a circumferential extent of the protruding portion delimited by the first and second circumferential ends is between 20 and 50 percent of a full circumference.

Embodiments of the third aspect of the disclosure can include any one or a combination of the following features:
a gear disposed within the gearbox region and operably coupled with the rotor shaft, wherein a radially-outboard-most portion of the gear is radially aligned with the protruding portion and the reference portion;
the housing includes an outlet that defines an opening for fluid to flow through from the gearbox region and along a fluid flow path therefrom, and wherein the outlet is positioned at the first circumferential end of the protruding portion; and
the circumferential extent of the protruding portion is no more than 35 percent of a full circumference.

These and other features, advantages, and objects of the present disclosure will be further understood and appreciated by those skilled in the art by reference to the following specification, claims, and appended drawings.

### BRIEF DESCRIPTION OF THE DRAWINGS

In the drawings:

FIG. 1 is a schematic view of a vehicle that includes an electric drive unit, according to one embodiment;

FIG. 2 is a perspective view of the electric drive unit, according to one embodiment;

FIG. 3 is a side elevational view of the electric drive unit, according to one embodiment;

FIG. 4 is a cross-sectional view of the electric drive unit of FIG. 3 taken at line IV-IV, illustrating a bearing shield of a housing that includes a protruding portion that is axially offset from a radially-outboard-most portion of a planet gear relatively less than a reference portion of the bearing shield, according to one embodiment;

FIG. 5 is an enlarged view of area V of FIG. 4, illustrating the protruding portion of a second side of the bearing shield and the planet gear disposed within a gearbox region of the housing proximate to the protruding portion, according to one embodiment;

FIG. 6 is an elevational view of a portion of a planetary gearset, illustrating a sun gear and a plurality of planet gears engaged with the sun gear at respective gear junctions, according to one embodiment;

FIG. 7 is an elevational view of a portion of the housing of the electric drive unit, illustrating a second side of a bearing shield that includes a reference portion and a protruding portion, according to one embodiment; and

FIG. 8 is an elevational view of a portion of an electric drive unit, illustrating a planetary gearset and a portion of a housing that includes a bearing shield having a protruding portion and a reference portion, according to one embodiment.

The components in the figures are not necessarily to scale, emphasis instead being placed upon illustrating the principles described herein.

### DETAILED DESCRIPTION

Additional features and advantages of the disclosure will be set forth in the detailed description which follows and will be apparent to those skilled in the art from the description, or recognized by practicing the disclosure as described in the following description, together with the claims and appended drawings.

As used herein, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination.

In this document, relational terms, such as “first” and “second,” “top” and “bottom,” and the like, are used solely to distinguish one entity or action from another entity or action, without necessarily requiring or implying any actual such relationship or order between such entities or actions.

For purposes of this disclosure, the term “coupled” (in all of its forms: couple, coupling, coupled, etc.) generally means the joining of two components (electrical or mechanical) directly or indirectly to one another. Such joining may be stationary in nature or movable in nature. Such joining may be achieved with the two components (electrical or mechanical) and/or any additional intermediate members. Such joining may include members being integrally formed as a single unitary body with one another (i.e., integrally coupled) or may refer to joining of two components. Such joining may be permanent in nature, or may be removable or releasable in nature, unless otherwise stated.

The terms “substantial,” “substantially,” and variations thereof as used herein are intended to note that a described feature is equal or approximately equal to a value or description. For example, a “substantially planar” surface is intended to denote a surface that is planar or approximately planar. Moreover, “substantially” is intended to denote that two values are equal or approximately equal. In some embodiments, “substantially” may denote values within about 10% of each other, such as within about 5% of each other, or within about 2% of each other.

As used herein, the terms “the,” “a,” or “an,” mean “at least one,” and should not be limited to “only one” unless explicitly indicated to the contrary. Thus, for example, reference to “a component” includes embodiments having two or more such components unless the context clearly indicates otherwise.

As used herein, the term “axial” and derivatives thereof, such as “axially,” shall be understood to refer to a direction along the axis of a shaft configured to rotate in operation of the apparatus described herein. Further, the term “radial” and derivatives thereof, such as “radially,” shall be understood in relation to the axis of the aforementioned shaft. For example, “radially outboard” refers to further away from the axis, while “radially inboard” refers to nearer to the axis. The term “circumferential” and derivatives thereof, such as “circumferentially,” shall be understood in relation to the axis of the aforementioned shaft.

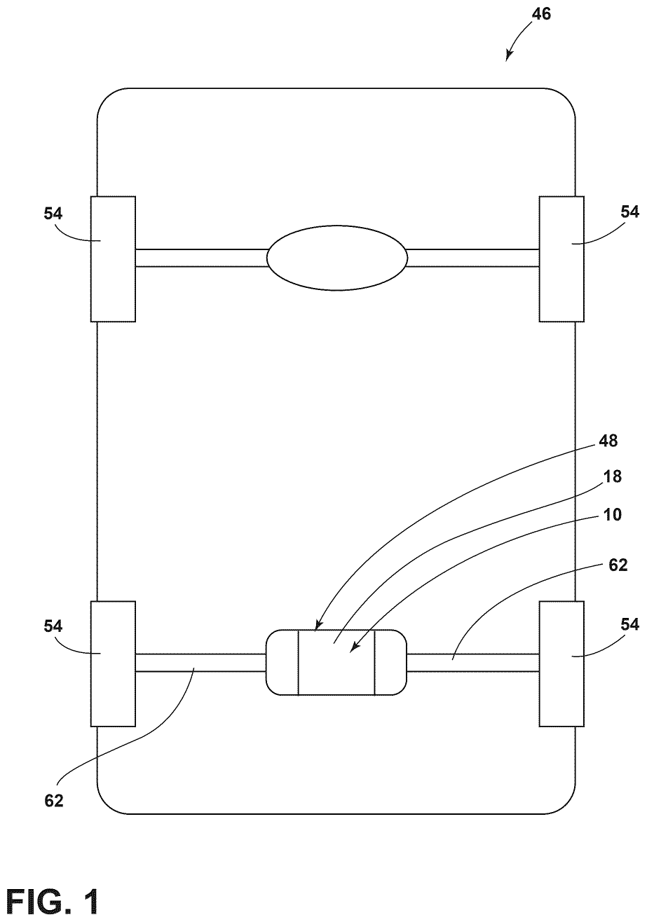

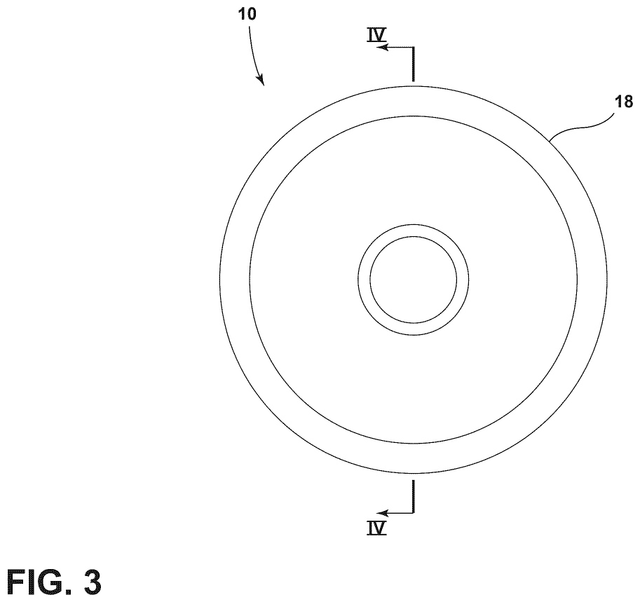

Referring now to FIGS. 1-8, an electric drive unit 10 includes a motor 12 that drives rotation of a rotor shaft 14 about an axis 16, a housing 18, and a planetary gearset 20. The housing 18 includes a bearing shield 22 that extends between a motor housing region 24 that houses the motor 12 and a gearbox region 26. The bearing shield 22 includes a first side 28 that faces toward the motor housing region 24 and a second side 30 opposite the first side 28 that includes a reference portion 32 and a protruding portion 34 that is adjacent to the reference portion 32. The protruding portion 34 protrudes axially outward relative to the reference portion 32 away from the motor housing region 24. The planetary gearset 20 is disposed within the gearbox region 26. The planetary gearset 20 includes a planet gear 36 that is meshed with a sun gear 38 at a gear junction 40. The planet gear 36 has a radially-outboard-most portion 42. A radially-aligned portion 44 of the second side 30 of the bearing shield 22 that is radially aligned with the radially-outboard-most portion 42 of the planet gear 36 is formed by the reference portion 32 and the protruding portion 34. The radially-outboard-most portion 42 of the planet gear 36 is axially offset from the portion of the radially-aligned portion 44 that is formed by the protruding portion 34 less than the radially-outboard-most portion 42 of the planet gear 36 that is axially offset from the portion of the radially-aligned portion 44 that is formed by the reference portion 32.

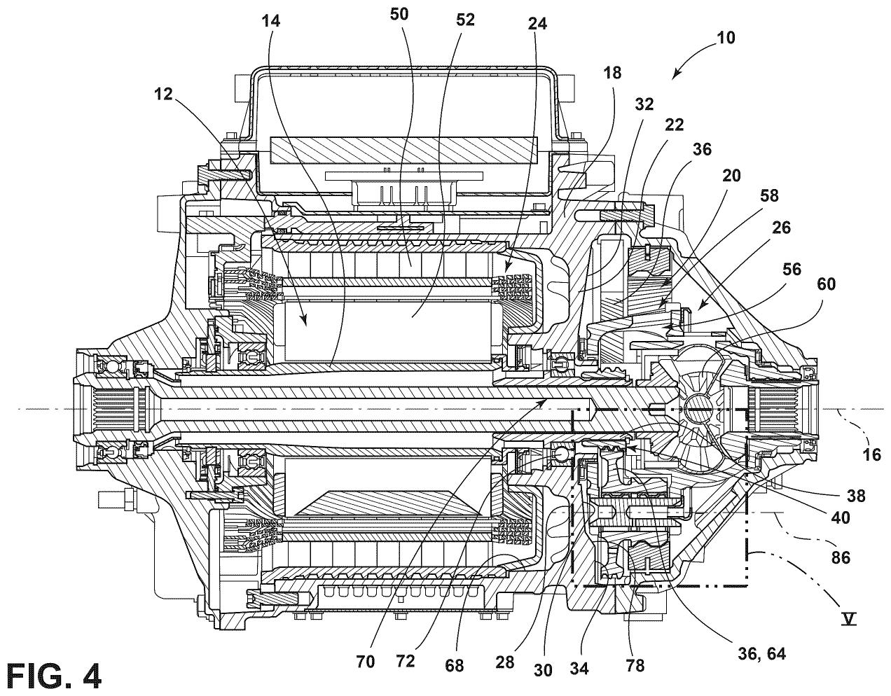

Referring now to FIG. 1, a vehicle 46 is illustrated. The vehicle 46 may be an electric vehicle and/or a hybrid electric vehicle. In the embodiment illustrated in FIG. 1, the vehicle 46 includes the electric drive unit 10. As illustrated, the electric drive unit 10 is a portion of an electric axle assembly 48 of the vehicle 46. As illustrated in FIG. 4, the electric drive unit 10 includes the electric motor 12, which includes a stator 50 and a rotor 52 that is configured to drive rotation of the rotor shaft 14, in various embodiments. The rotor shaft 14 can be operably coupled with at least one wheel 54 of the vehicle 46, such that rotation of the rotor shaft 14 drives rotation of the at least one wheel 54 in operation of the electric drive unit 10. In various implementations, the electric drive unit 10 of the vehicle 46 includes a transmission 56. The transmission 56 can include a gearset 58, such as the planetary gearset 20, as described further herein. Further, a differential 60 may be operably coupled with the gearset 58. The gearset 58 may be configured to interface with the rotor shaft 14 and the differential 60, as described further herein. The differential 60 may be configured to interface with half shafts 62 of the vehicle 46 that are coupled with the wheels 54 of the vehicle 46. As such, rotation of the rotor shaft 14 by the electric motor 12 can drive rotation of the half shafts 62 and the attached wheels 54 of the vehicle 46 via the operable coupling of the half shafts 62 to the rotor shaft 14 by the gearset 58 and the differential 60.

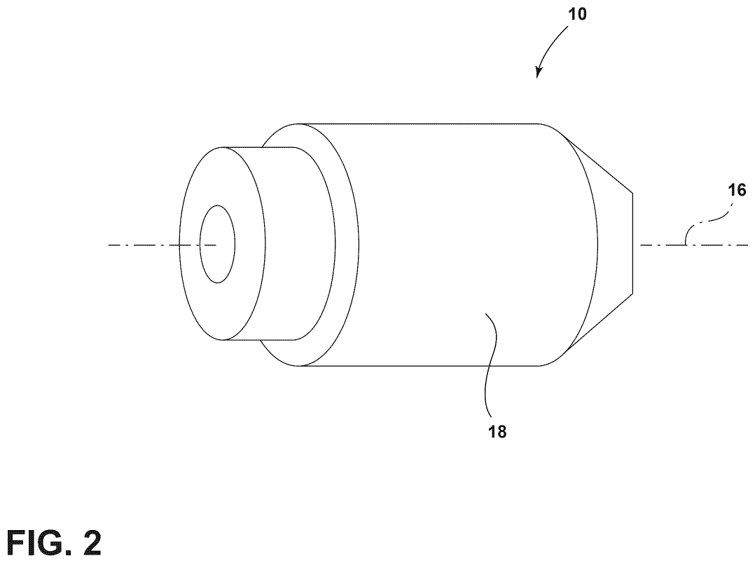

Referring now to FIGS. 2-5, 7, and 8, the electric drive unit 10 includes the housing 18. The housing 18 can be an assembly of a plurality of components, in some examples. For example, the housing 18 can be a die-cast aluminum housing that is formed of a plurality of components. The housing 18 can define the motor housing region 24 and the gearbox region 26. The motor 12 of the electric drive unit 10 can be housed within the motor housing region 24. The gearbox region 26 defined by the housing 18 can contain a plurality of electric drive unit components, such as one or more gears 64 of the gearset 58 and the differential 60. Further, the gearbox region 26 may serve as a reservoir for fluid 66, such as oil, as described further herein. The housing 18 includes the bearing shield 22. The bearing shield 22 extends radially inboard from an outer wall 68 of the housing 18 and is arranged to generally separate the gearbox region 26 from the motor housing region 24. As illustrated in FIG. 4, the bearing shield 22 can define a central aperture 70. The axis 16 about which the rotor shaft 14 of the motor 12 is configured to rotate may extend through the central aperture 70, in various embodiments. A bearing 72 can be positioned radially between the bearing shield 22 and the rotor shaft 14 of the electric motor 12, as illustrated in FIG. 4. The bearing 72 can support and facilitate rotation of the rotor shaft 14 about the axis 16. In some implementations, a dynamic seal (not shown) may be arranged between the bearing shield 22 and the rotor shaft 14 to prevent or restrict fluid 66, such as oil, from entering the motor housing region 24 from the gearbox region 26.

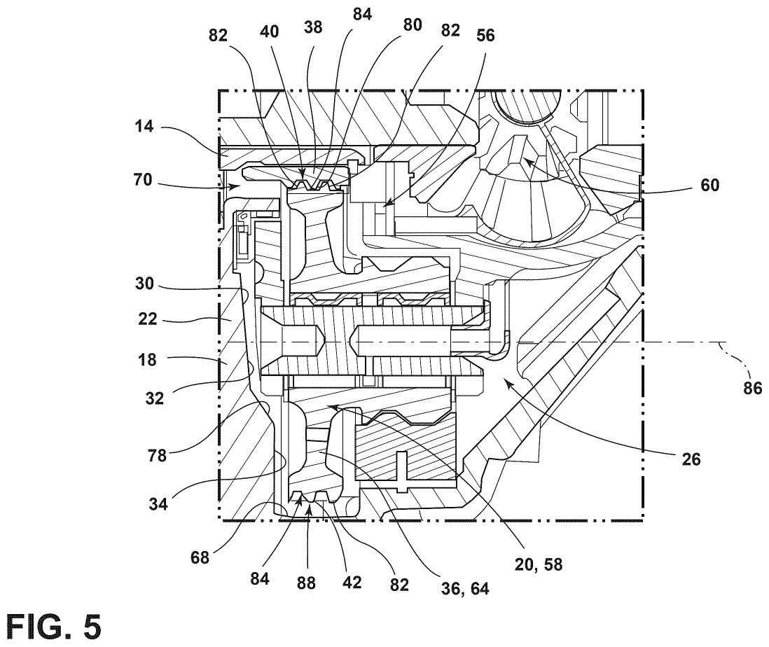

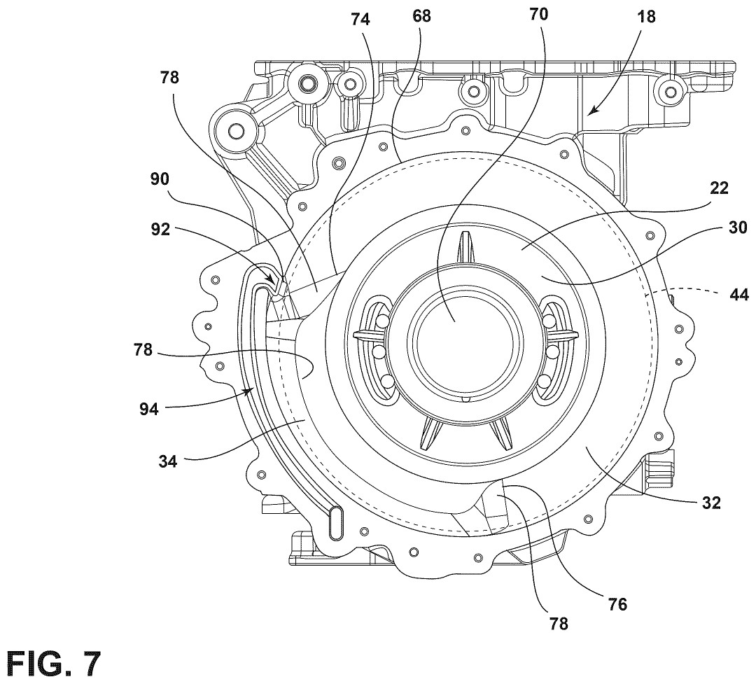

Referring now to FIGS. 4, 5, and 7, the bearing shield 22 includes the first side 28 and the second side 30 opposite the first side 28. The first side 28 of the bearing shield 22 faces toward the motor housing region 24. The second side 30 of the bearing shield 22 faces toward the gearbox region 26. In various implementations, the second side 30 of the bearing shield 22 at least partially defines the gearbox region 26 of the housing 18, as illustrated in FIGS. 4 and 5. The second side 30 of the bearing shield 22 can include a reference portion 32 and a protruding portion 34. The protruding portion 34 may be adjacent to the reference portion 32 and may protrude axially outward relative to the reference portion 32 away from the motor housing region 24 of the housing 18. In various implementations, the reference portion 32 of the second side 30 of the bearing shield 22 is radially aligned with the protruding portion 34. As illustrated in FIG. 7, the protruding portion 34 extends circumferentially between a first circumferential end 74 of the protruding portion 34 and a second circumferential end 76 of the protruding portion 34. The first and second circumferential ends 74, 76 of the protruding portion 34 may delimit a circumferential extent of the protruding portion 34. As illustrated in FIG. 7, wherein the reference portion 32 is aligned with the protruding portion 34, the protruding portion 34 extends in a first circumferential direction from the first circumferential end 74 to the second circumferential end 76 of the protruding portion 34, and the reference portion 32 extends from the second circumferential end 76 of the protruding portion 34 to the first circumferential end 74 of the protruding portion 34 in the first circumferential direction. In various embodiments, the protruding portion 34 is integrally coupled with the bearing shield 22. In some implementations, the protruding portion 34 is a component that is assembled to the bearing shield 22.

Referring still to FIGS. 4, 5, and 7, the circumferential extent of the protruding portion 34 that extends between the first and second circumferential ends 74, 76 of the protruding portion 34 can have a variety of sizes in various implementations. For example, in some embodiments, the circumferential extent of the protruding portion 34 is no more than 50 percent of a full circumference (e.g., extends circumferentially no more than 180°). In some implementations, the circumferential extent of the protruding portion 34 is no more than 35 percent of a full circumference. In some implementations, the circumferential extent of the protruding portion 34 is between 20 percent and 50 percent of a full circumference. In some implementations, the circumferential extent of the protruding portion 34 is about 35 percent of a full circumference.

Referring still to FIGS. 4, 5, and 7, in some implementations, the protruding portion 34 includes a beveled portion 78. In various implementations, the beveled portion 78 extends to a portion of the bearing shield 22 that is adjacent to the protruding portion 34. For example, in various implementations, the beveled portion 78 extends and is adjacent to the reference portion 32 of the second side 30 of the bearing shield 22. In some embodiments, the beveled portion 78 forms the first circumferential end 74 of the protruding portion 34 and/or the second circumferential end 76 of the protruding portion 34. In some implementations, the beveled portion 78 slopes radially inboard toward the adjacent portion of the second side 30 of the bearing shield 22 before terminating. In the exemplary embodiment illustrated in FIG. 7, the protruding portion 34 includes a plurality of beveled portions 78 that cooperate to form the first and second circumferential ends 74, 76 of the protruding portion 34 and bound the radially inboard perimeter of the protruding portion 34.

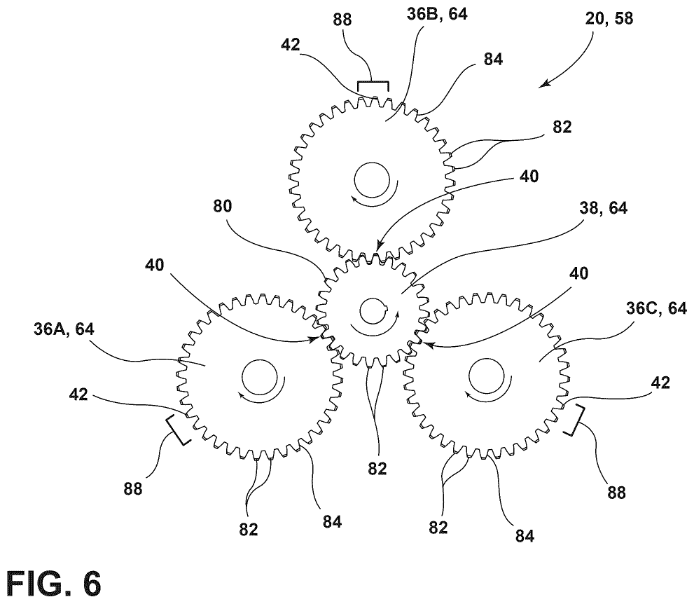

Referring now to FIGS. 4-8, the electric drive unit 10 can include the gearset 58. The gearset 58 can include a plurality of gears 64 that are disposed within the gearbox region 26 of the housing 18. In various implementations, the electric drive unit 10 includes the planetary gearset 20 that is disposed within the gearbox region 26. The planetary gearset 20 includes the sun gear 38. The sun gear 38 may be operably coupled with the rotor shaft 14, as illustrated in FIGS. 4 and 5, such that the sun gear 38 and rotor shaft 14 are configured to rotate together at a common rate of rotation about the axis 16. The sun gear 38 includes a sun gear engagement face 80. The sun gear engagement face 80 may include a plurality of teeth 82 that are configured to engage corresponding teeth 82 of other gears 64 within the planetary gearset 20, as described further herein. The planetary gearset 20 further includes the planet gear 36. In various implementations, the planetary gearset 20 includes a plurality of planet gears 36. Each of the plurality of planet gears 36 includes a planet gear engagement face 84. The planet gear engagement face 84 includes a plurality of teeth 82. The planet gear engagement face 84 meshes with the sun gear engagement face 80 at the gear junction 40. As illustrated in FIG. 6, the plurality of planet gears 36 includes first, second, and third planet gears 36A, 36B, 36C, each of which meshes with the sun gear 38 at a respective gear junction 40. In various implementations, each of the planet gears 36 meshes with the sun gear 38, such that rotation of the sun gear 38 about the axis 16 prompts each planet gear 36 to revolve about the axis 16 and rotate about a respective planet gear axis 86. The planet gear axes 86 about which the planet gears 36 respectively rotate revolve about the axis 16 in operation of the electric drive unit 10.

Referring still to FIGS. 4-8, in operation of the electric drive unit 10, wherein the planet gears 36 are rotating about respective planet gear axes 86 and revolving about the axis 16 due to rotation of the rotor shaft 14 and sun gear 38 by the motor 12, various teeth 82 of the planet gear engagement face 84 of each planet gear 36 enter and exit a radially distal zone 88 of each of the respective planet gears 36. For each of the plurality of planet gears 36, respectively, the radially distal zone 88 of the planet gear engagement face 84 is circumferentially aligned with the gear junction 40 and is positioned radially outboard and opposite of the portion of the planet gear engagement face 84 that is meshed with the sun gear engagement face 80 at the gear junction 40. As illustrated in FIG. 6, in various implementations, the radially-outboard-most portion 42 of the planet gear 36 at a given point in time is a portion of the radially distal zone 88 of the planet gear engagement face 84 of the planet gear 36 at the given point in time. It is to be understood that, as the planet gear 36 revolves about the axis 16 and rotates about the planet gear axis 86, the portion of the planet gear 36 that forms the radially distal zone 88 may vary based on the rotational position of the planet gear 36 relative to the planet gear axis 86 and the circumferential position of the planet gear 36 relative to the axis 16. Further, the radially-outboard-most portion 42 of the planet gear 36 at a first rotational and circumferential position of the planet gear 36 may be formed by a different tooth 82 of the planet gear engagement face 84 than when the planet gear 36 is in a second rotational and circumferential position.

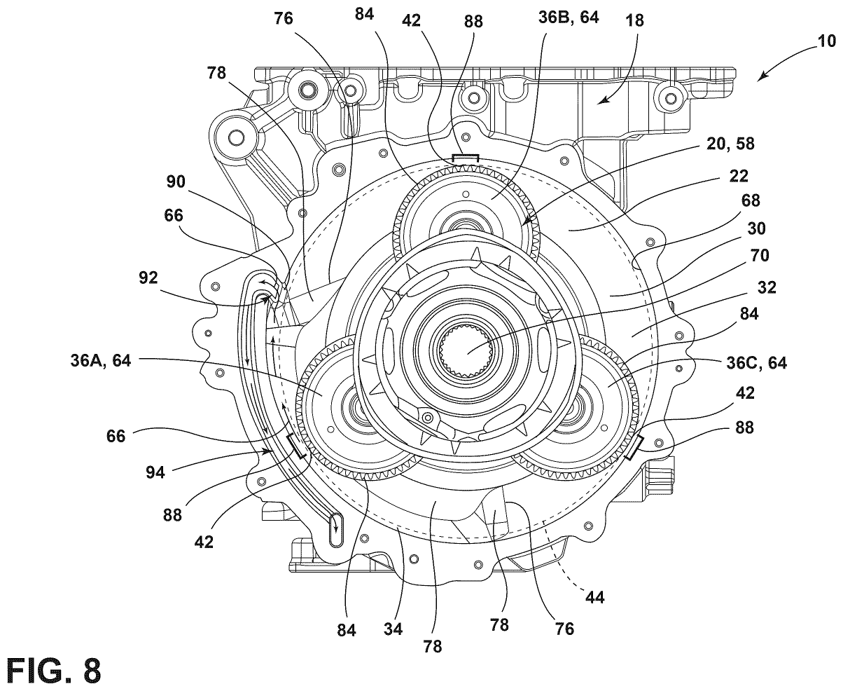

Referring still to FIGS. 4-8, in various implementations, the radially distal zone 88 of each of the plurality of planet gears 36 is radially aligned with the protruding portion 34 of the second side 30 of the bearing shield 22. For example, as illustrated in FIG. 8, the radially distal zone 88 of each of the plurality of planet gears 36 is radially aligned with the protruding portion 34. As further illustrated in FIG. 8, the radially distal zone 88 of each of the planet gears 36, respectively, may be circumferentially aligned with and/or offset from the protruding portion 34 of the second side 30 of the bearing shield 22, because the circumferential extent of the protruding portion 34 does not extend along a full circumference. For example, as illustrated in FIG. 8, the radially distal zone 88 of the planet gear engagement face 84 of the first planet gear 36A is circumferentially aligned with the protruding portion 34, while the respective radially distal zones 88 of the planet gear engagement faces 84 of the second and third planet gears 36B, 36C are circumferentially offset from the protruding portion 34 and are instead circumferentially aligned with the reference portion 32 of the second side 30 of the bearing shield 22. In various embodiments, when the radially distal zone 88 of the planet gear engagement face 84 is circumferentially aligned with the protruding portion 34, the radially distal zone 88 of the planet gear engagement face 84 is nearer to the second side 30 of the bearing shield 22 than the radially distal zone 88 of the planet gear engagement face 84 is when the radially distal zone 88 of the planet gear engagement face 84 is circumferentially offset from the protruding portion 34. In other words, the clearance between the second side 30 of the bearing shield 22 in the radially distal zone 88 of the planet gear 36 is smaller when the radially distal zone 88 is circumferentially aligned with the protruding portion 34 than when the radially distal zone 88 is circumferentially aligned with the reference portion 32. This may encourage splashing of fluid 66 disposed within the fluid reservoir to a greater degree while the radially distal zone 88 is circumferentially aligned with the protruding portion 34, as described further herein.

Referring still to FIGS. 4-8, a radially-aligned portion 44 of the second side 30 of the bearing shield 22 is radially aligned with the radially-outboard-most portion 42 of the planet gear 36. As illustrated in FIG. 8, the radially-aligned portion 44 of the second side 30 of the bearing shield 22 is formed by the reference portion 32 of the second side 30 and the protruding portion 34 of the second side 30. In various implementations, the radially-outboard-most portion 42 of the planet gear 36 is axially offset from the portion of the radially-aligned portion 44 that is formed by the protruding portion 34 less than the radially-outboard-most portion 42 of the planet gear 36 is axially offset from the portion of the radially-aligned portion 44 that is formed by the reference portion 32. In various embodiments, the radially-aligned portion 44 of the second side 30 extends along a full circumference. It is contemplated that the radially-aligned portion 44 of the second side 30 may extend along a portion of the full circumference, in some implementations. In some implementations, the reference portion 32 and the protruding portion 34 of the second side 30 form the entirety of the radially-aligned portion 44 of the second side 30 of the bearing shield 22. As illustrated in FIGS. 7 and 8, in various implementations, the reference portion 32 forms a greater percentage of the radially-aligned portion 44 than the protruding portion 34. In some implementations, the protruding portion 34 forms between 20 percent and 40 percent of the radially-aligned portion 44. For example, in an embodiment, wherein the radially-aligned portion 44 extends along a full circumference, the protruding portion 34 may form between 20 percent and 40 percent of the radially-aligned portion 44 of the second side 30 of the bearing shield 22.

Referring now to FIGS. 7 and 8, the housing 18 can include an outlet 90 that defines an opening 92 for fluid 66 to flow through from the gearbox region 26 and along a fluid flow path 94 therefrom. For example, as illustrated in FIG. 7, the housing 18 includes the outlet 90 that defines the opening 92 proximate to the first circumferential end 74 of the protruding portion 34 of the second side 30 of the bearing shield 22. In the illustrated embodiment, the outlet 90 is adjacent to the beveled portion 78 of the protruding portion 34 that is proximate to the first circumferential end 74 of the protruding portion 34. This placement may advantageously encourage fluid 66 to flow along the beveled portion 78 and into the opening 92 defined by the outlet 90.

In operation of an exemplary embodiment of the electric drive unit 10, the motor 12 drives rotation of the rotor shaft 14 and the sun gear 38 operably coupled thereto about the axis 16, which drives revolution of the plurality of planet gears 36 about the axis 16 and rotation of the plurality of planet gears 36 about the respective planet gear axes 86. The revolution of the planet gears 36 about the axis 16 and rotation of each of the planet gears 36 about the respective planet gear axes 86 prompted by the rotation of the operably coupled rotor shaft 14 is configured to splash fluid 66 within the gearbox region 26 that is radially and circumferentially aligned with the protruding portion 34 of the second side 30 of the bearing shield 22 toward the opening 92 defined by the outlet 90 of the housing 18.

The present disclosure may provide a variety of advantages. First, the second side 30 of the bearing shield 22 including the protruding portion 34 may reduce the distance between the radially distal zone 88 of the planet gear engagement face 84 of a planet gear 36 that is circumferentially aligned with the protruding portion 34 and the second side 30 of the bearing shield 22 relative to when the radially distal zone 88 is circumferentially aligned with the reference portion 32 of the second side 30 of the bearing shield 22. This encourages splashing of fluid 66 within the gearbox region 26 that is radially and circumferentially aligned with the protruding portion 34 of the second side 30. Second, the outlet 90 of the housing 18 that defines the opening 92 being disposed at the first circumferential end 74 of the protruding portion 34 allows for the increased splashing of fluid 66 at the protruding portion 34 to result in an increased amount of fluid 66 entering the opening 92 defined by the outlet 90, which is ideal for optimal performance of the electric drive unit 10 without the need for a fluid pump. Third, the circumferential extent of the protruding portion 34 being limited relative to the extent of a full circumference (e.g., between 20 percent and 40 percent of a full circumference) enables the aforementioned benefits of the protruding portion 34 while decreasing energy loss due to drag from the fluid 66 contacting the planet gears 36 that occurs at a greater incidence due to the protruding portion 34. Notably, the circumferential extent of the protruding portion 34 being limited relative to the full circumference, as illustrated in FIGS. 7 and 8, was tested to determine energy loss due to drag from fluid 66 contacting the planet gears 36. The test results showed that the limited circumferential extent of the protruding portion 34 resulted in substantially less energy loss compared to systems that incorporate a protruding portion 34 that extends about a full circumference. Further, test results showed that the energy loss was negligible compared to a system that omitted the protruding portion 34 entirely.

It is to be understood that variations and modifications can be made on the aforementioned structure without departing from the concepts of the present disclosure, and further it is to be understood that such concepts are intended to be covered by the following claims unless these claims by their language expressly state otherwise.

### List of Reference Numerals

10 electric drive unit
12 motor
14 rotor shaft
16 axis
18 housing
20 planetary gearset
22 bearing shield
24 motor housing region
26 gearbox region
28 first side
30 second side
32 reference portion
34 protruding portion
36 planet gear
36A first
36B second
36C third
38 sun gear
40 gear junction
42 radially-outboard-most portion
44 radially-aligned portion
46 vehicle
48 electric axle assembly
50 stator
52 rotor
54 wheel
56 transmission
58 gearset
60 differential
62 half shaft
64 gear(s)
66 fluid
68 outer wall
70 central aperture
72 bearing
74 first circumferential end
76 second circumferential end
78 beveled portion
80 sun gear engagement face
82 teeth
84 planet gear engagement face
86 planet gear axes
88 radially distal zone
90 outlet
92 opening
94 fluid flow path

What is claimed is:

1. An electric drive unit, comprising:
a motor that drives rotation of a rotor shaft about an axis;
a housing that includes a bearing shield that extends between a motor housing region that houses the motor and a gearbox region, the bearing shield having a first side that faces toward the motor housing region and a second side opposite the first side that includes a protruding portion; and
a planetary gearset disposed within the gearbox region and comprising:
a sun gear that includes a sun gear engagement face and is operably coupled with the rotor shaft such that the sun gear and the rotor shaft are configured to rotate together at a common rate of rotation about the axis; and
a plurality of planet gears, each having a planet gear engagement face that meshes with the sun gear engagement face at a gear junction, such that rotation of the sun gear about the axis prompts each planet gear to revolve about the axis and rotate about a respective planet gear axis, wherein, for each of the plurality of planet gears respectively, a radially distal zone of the planet gear engagement face that is circumferentially aligned with the gear junction and radially outboard and opposite of the portion of the planet gear engagement face that is meshed with the sun gear engagement face at the gear junction is radially aligned with the protruding portion of the second side of the bearing shield, wherein, when the radially distal zone of the planet gear engagement face is circumferentially aligned with the protruding portion, the radially distal zone of the planet gear engagement face is nearer to the second side of the bearing shield than the radially distal zone of the planet gear engagement face is when the radially distal zone of the planet gear engagement face is circumferentially offset from the protruding portion.

2. The electric drive unit of claim 1, wherein the protruding portion of the second side of the bearing shield protrudes outward in an axial direction away from the first side of the bearing shield relative to an adjacent portion of the second side of the bearing shield.

3. The electric drive unit of claim 2, wherein the protruding portion of the second side of the bearing shield extends circumferentially between first and second circumferential ends of the protruding portion that delimit a circumferential extent of the protruding portion.

4. The electric drive unit of claim 3, wherein the circumferential extent of the protruding portion is no more than 50 percent of a full circumference.

5. The electric drive unit of claim 4, wherein the circumferential extent of the protruding portion is between 20 percent and 50 percent of a full circumference.

6. The electric drive unit of claim 5, wherein the circumferential extent of the protruding portion is no more than 35 percent of a full circumference.

7. The electric drive unit of claim 6, wherein the circumferential extent of the protruding portion is about 35 percent of a full circumference.

8. The electric drive unit of claim 3, wherein the protruding portion of the second side of the bearing shield includes a beveled portion that extends to the adjacent portion of the bearing shield.

9. The electric drive unit of claim 8, wherein the housing includes an outlet that defines an opening for fluid to flow through from the gearbox region and along a fluid flow path therefrom, wherein the outlet is adjacent to the beveled portion proximate the first circumferential end.

10. The electric drive unit of claim 9, wherein revolution of the planet gears about the axis and rotation of each of the planet gears about the respective planet gear axes prompted by rotation of the operably coupled rotor shaft is configured to splash fluid that is radially and circumferentially aligned with the protruding portion toward the opening defined by the outlet.

11. An electric drive unit, comprising:
a motor that drives rotation of a rotor shaft about an axis;
a housing that includes a bearing shield that extends between a motor housing region that houses the motor and a gearbox region, the bearing shield having a first side that faces toward the motor housing region and a second side opposite the first side that includes a reference portion and a protruding portion that is adjacent to the reference portion and that protrudes axially outward relative to the reference portion away from the motor housing region; and
a planetary gearset disposed within the gearbox region and having a planet gear that is meshed with a sun gear at a gear junction and that has a radially-outboard-most portion, wherein a radially-aligned portion of the second side of the bearing shield that is radially aligned with the radially-outboard-most portion of the planet gear is formed by the reference portion and the protruding portion, and wherein the radially-outboard-most portion of the planet gear is axially offset from the portion of the radially-aligned portion that is formed by the protruding portion less than the radially-outboard-most portion of the planet gear is axially offset from the portion of the radially-aligned portion that is formed by the reference portion.

12. The electric drive unit of claim 11, wherein the radially-aligned portion of the second side extends along a full circumference.

13. The electric drive unit of claim 12, wherein the reference portion and the protruding portion form the entirety of the radially-aligned portion of the second side of the bearing shield.

14. The electric drive unit of claim 13, wherein the reference portion forms a greater percentage of the radially-aligned portion than the protruding portion.

15. The electric drive unit of claim 14, wherein the protruding portion forms between 20 percent and 40 percent of the radially-aligned portion.

16. The electric drive unit of claim 15, wherein the protruding portion includes a beveled portion that is adjacent to the reference portion.

17. An electric drive unit, comprising:
a motor that drives rotation of a rotor shaft about an axis; and
a housing that includes a bearing shield that extends between a motor housing region that houses the motor and a gearbox region, the bearing shield having a first side that faces toward the motor housing region and a second side opposite the first side that includes a reference portion and a protruding portion that is adjacent to the reference portion and that protrudes axially outward relative to the reference portion away from the motor housing region, wherein the reference portion is radially aligned with the protruding portion, the protruding portion extends circumferentially between first and second circumferential ends of the protruding portion in a first circumferential direction, the reference portion extends from the second circumferential end of the protruding portion to the first circumferential end of the protruding portion in the first circumferential direction, and a circumferential extent of the protruding portion delimited by the first and second circumferential ends is between 20 and 50 percent of a full circumference.

18. The electric drive unit of claim 17, furthering comprising:
a gear disposed within the gearbox region and operably coupled with the rotor shaft, wherein a radially-outboard-most portion of the gear is radially aligned with the protruding portion and the reference portion.

19. The electric drive unit of claim 17, wherein the housing includes an outlet that defines an opening for fluid to flow through from the gearbox region and along a fluid flow path therefrom, and wherein the outlet is positioned at the first circumferential end of the protruding portion.

20. The electric drive unit of claim 17, wherein the circumferential extent of the protruding portion is no more than 35 percent of a full circumference.
